(19) United States
(12) Patent Application Publication
(10) Pub. No.: US 2010/0242711 A1
(43) Pub. Date: Sep. 30, 2010

(54) METHOD, CIRCUIT AND SYSTEM FOR INTERFACING WITH AN ELECTRONIC DEVICE

(76) Inventors: Omer Yosha, Berlin (DE); Refael Yosha, Nes-Ziona (IL)

Correspondence Address: Professional Patent Solutions, P.O. BOX 654, HERZELIYA PITUACH, 46105, IL

(21) Appl. No.: 12/744,340

(22) PCT Filed: Nov. 26, 2008
(86) PCT No.: PCT/IL08/01544

§ 371 Date: May 24, 2010

Related U.S. Application Data
(60) Provisional application No. 60/989,986, filed on Nov. 26, 2007.

(51) Int. Cl. G10H 7/00; G09G 5/00

(52) U.S. Cl. 84/645; 341/20

(57) ABSTRACT

According to some embodiments of the present invention, there is provided a device, system and method for interfacing with an electronic appliance, including a sound generator. According to some embodiments of the present invention, there is provided an array of pulsed radiation emitters and/or sensors, wherein each emitter/sensor of the array, or any combination of emitters/sensors, may be associated with a different set of appliance control signals.

### FIELD OF THE INVENTION

The present invention relates generally to the field of interfacing with an electronic device.

### BACKGROUND

One of the largest patterns in the history of software is the shift from computation-intensive design to presentation-intensive design. As machines have become more and more powerful, inventors have spent a steadily increasing fraction of that power on presentation. The history of that progression can be conveniently broken into three eras: batch (1945-1968), command-line (1969-1983) and graphical (1984 and after). The story begins, of course, with the invention of the digital computer. The opening dates on the latter two eras are the years when vital new interface technologies broke out of the laboratory and began to transform users' expectations about interfaces in a serious way. Those technologies were interactive timesharing and the graphical user interface.

Command-line interfaces (CLIs) evolved from batch monitors connected to the system console. Their interaction model was a series of request-response transactions, with requests expressed as textual commands in a specialized vocabulary. Latency was far lower than for batch systems, dropping from days or hours to seconds. Accordingly, command-line systems allowed the user to change his or her mind about later stages of the transaction in response to real-time or near-real-time feedback on earlier results. Software could be exploratory and interactive in ways not possible before. But these interfaces still placed a relatively heavy mnemonic load on the user, requiring a serious investment of effort and learning time to master.

Command-line interfaces were closely associated with the rise of timesharing computers. The concept of timesharing dates back to the 1950s; the most influential early experiment was the MULTICS operating system after 1965; and by far the most influential of present-day command-line interfaces is that of Unix itself, which dates from 1969 and has exerted a shaping influence on most of what came after it.

The widespread adoption of wireless communication methods (e.g. Wifi, Bluetooth, IrDA, Zigbee etc.) has raised a demand for a wireless, more “virtual” way of interfacing with an electronic device.

There is a need in the field of computing for an improved method of interfacing with an electronic device using a graphical user interface.

### SUMMARY OF THE INVENTION

According to some embodiments of the present invention, there is provided a system and method for human machine interface. According to further embodiments of the present invention, sensors or detectors may be arranged upon an interface base.

According to some embodiments of the present invention, the array of sensors may form a matrix of virtual keys. According to further embodiments of the present invention, positions of virtual keys may be described in reference to any X, Y and Z coordinate set, where: X denotes horizontal position; Y denotes vertical position; and Z denotes depth position.

According to some embodiments of the present invention, each of the sensors or detectors may be adapted to output an electrical signal indicating the distance of a user limb or a user manipulated object, from it.

According to some embodiments of the present invention, one or more signal-acquisition circuits may be adapted to receive the output signals from each of the sensors or detectors, whereas a signal processing logic may be adapted to estimate the position and a velocity vector of the limb or the user manipulated object in relation to the sensors.

According to some embodiments of the present invention, a command issuing logic may be adapted to convert the estimated position or velocity vector into a machine command, by referencing a mapping table.

According to some embodiments of the present invention, the output signals of the sensors or detectors may be an analog signal. The signal-acquisition circuits receiving the output signals from each of the sensors or detectors, may comprise an analog to digital converter for converting the analog signals they may receive into digital signals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an exemplary system in accordance with some embodiments of the present invention;

FIG. 2 is a block diagram of an exemplary system in accordance with some embodiments of the present invention;

FIG. 3 is a schematic showing a Virtual Matrix Generator in accordance with some embodiments of the present invention;

FIG. 4 is a schematic showing a Virtual Matrix Generator and a Virtual Key Generator in accordance with some embodiments of the present invention;

FIG. 5 is a flow chart showing the steps of an exemplary embodiment of the present invention;

FIG. 6A is a flow chart showing the logic flow of an exemplary controller, in accordance with some embodiments of the present invention.

FIG. 6B is a table defining the variables, functions and values used by the exemplary controller's logic flow algorithm shown in FIG. 8A, in accordance with some embodiments of the present invention.

FIG. 7A is scheme showing two known in the art ways of representing a vector in a coordinate system

FIG. 7B is a scheme showing an exemplary vector calculation problem of an airplane travelling in the wind.

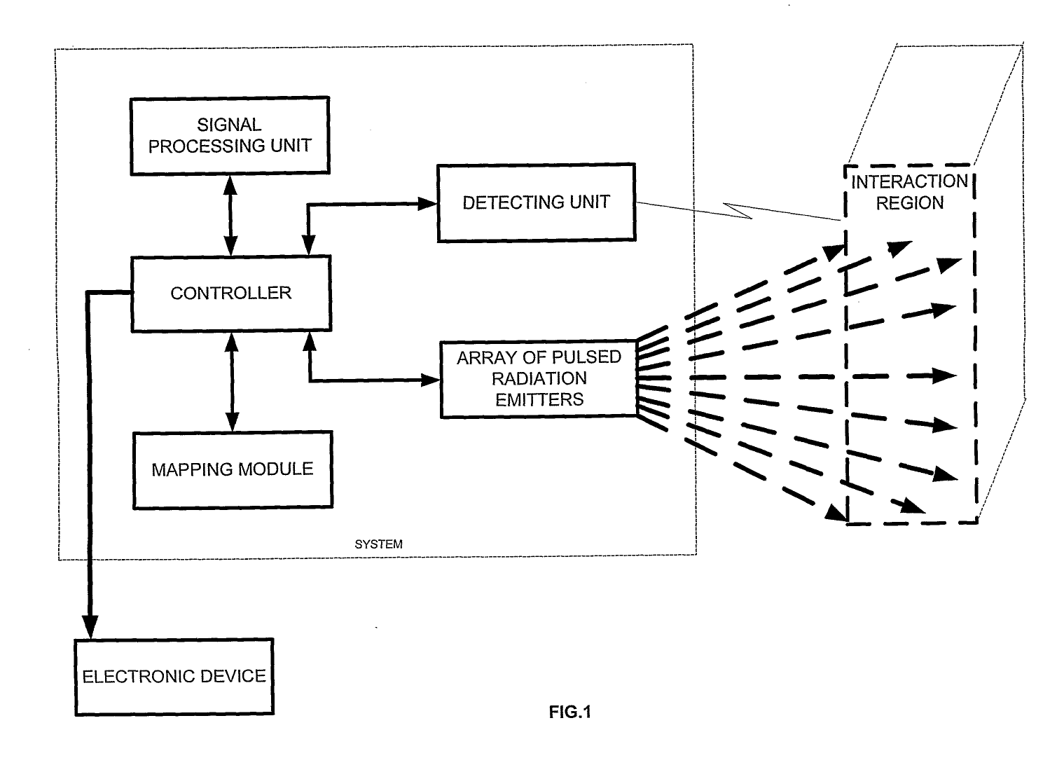

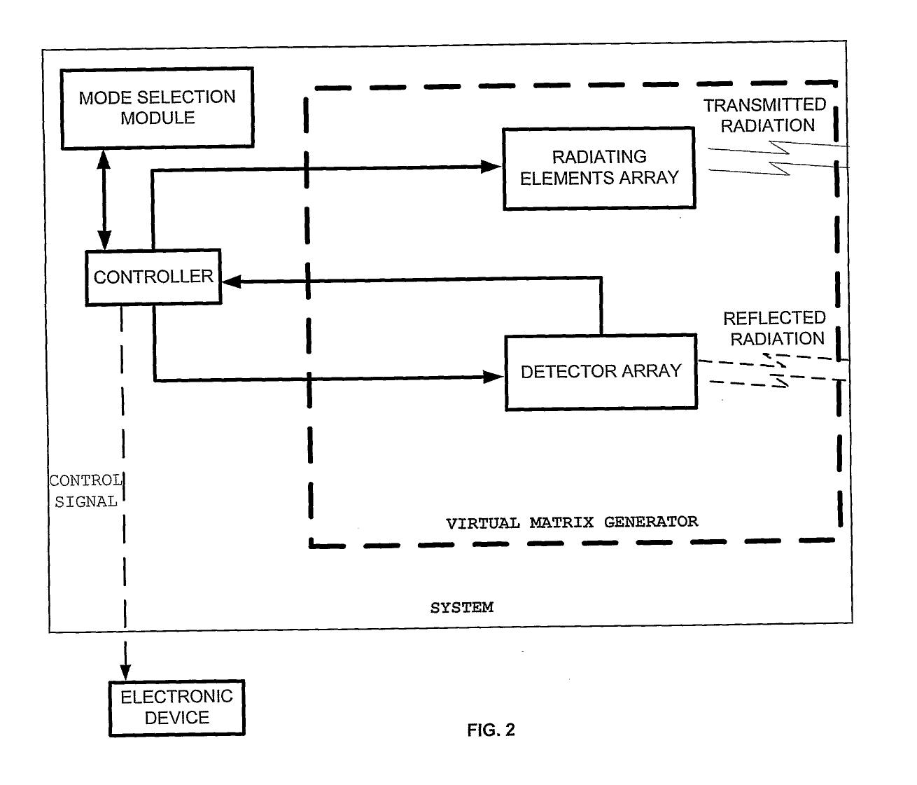

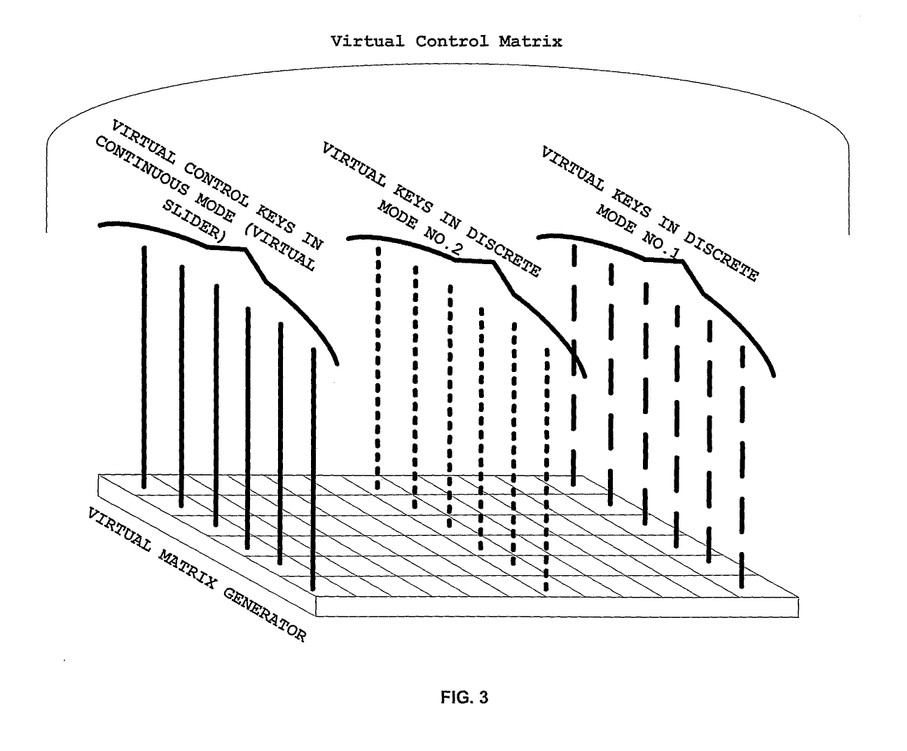

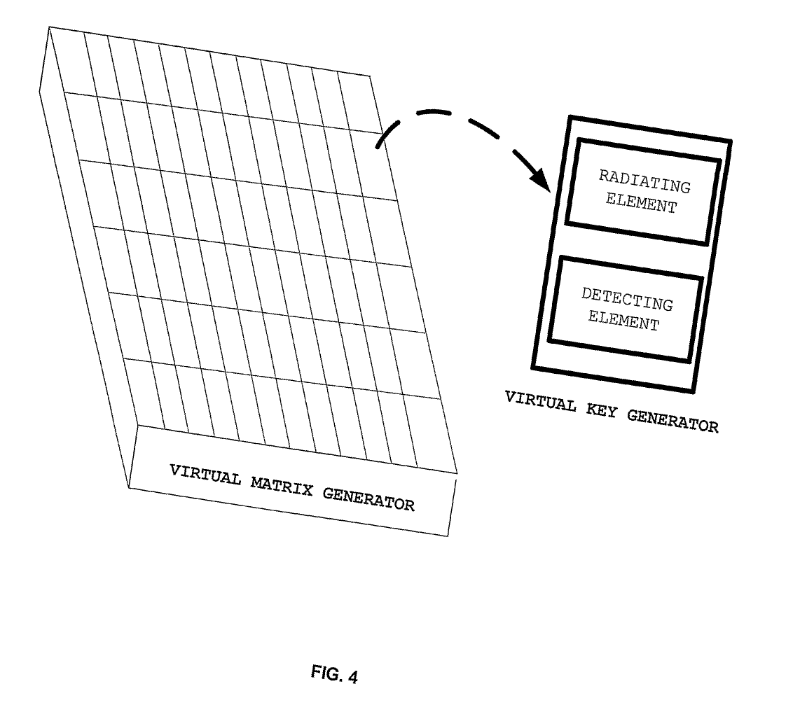

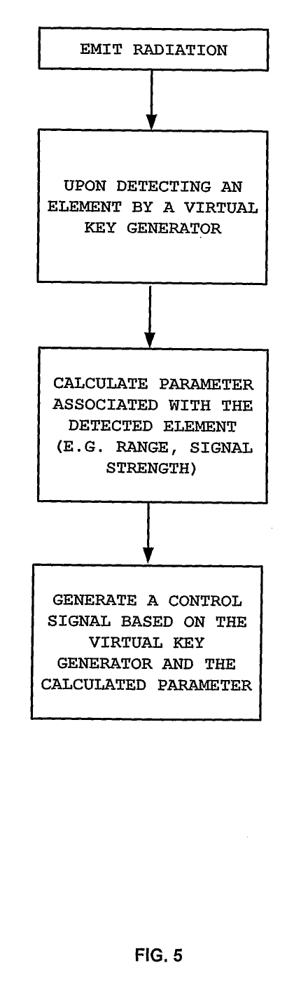

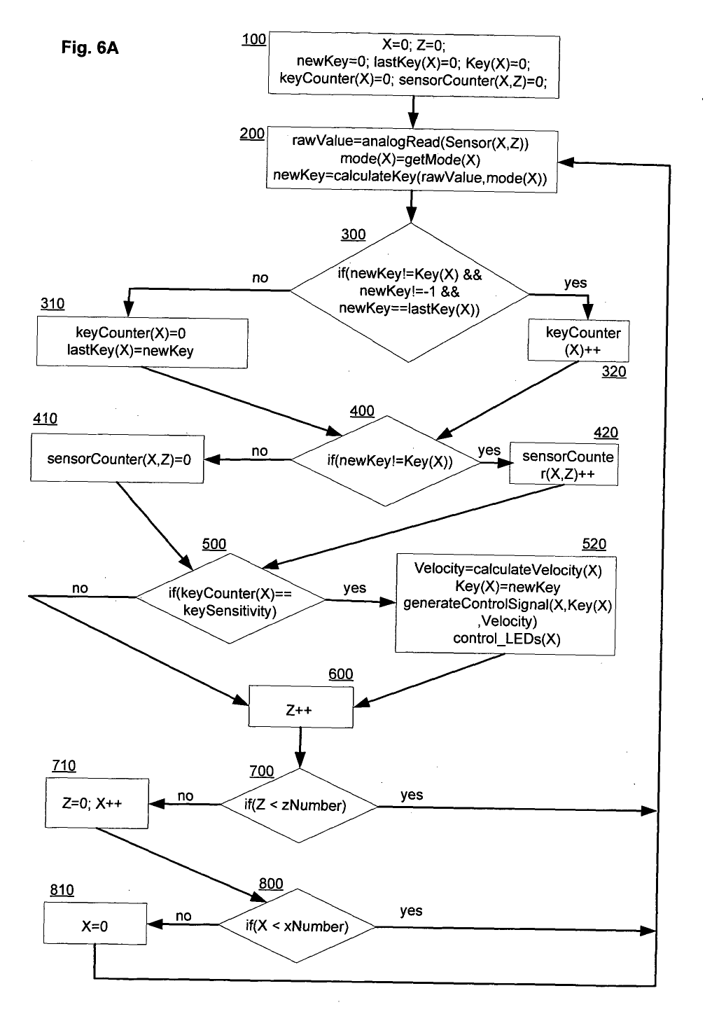

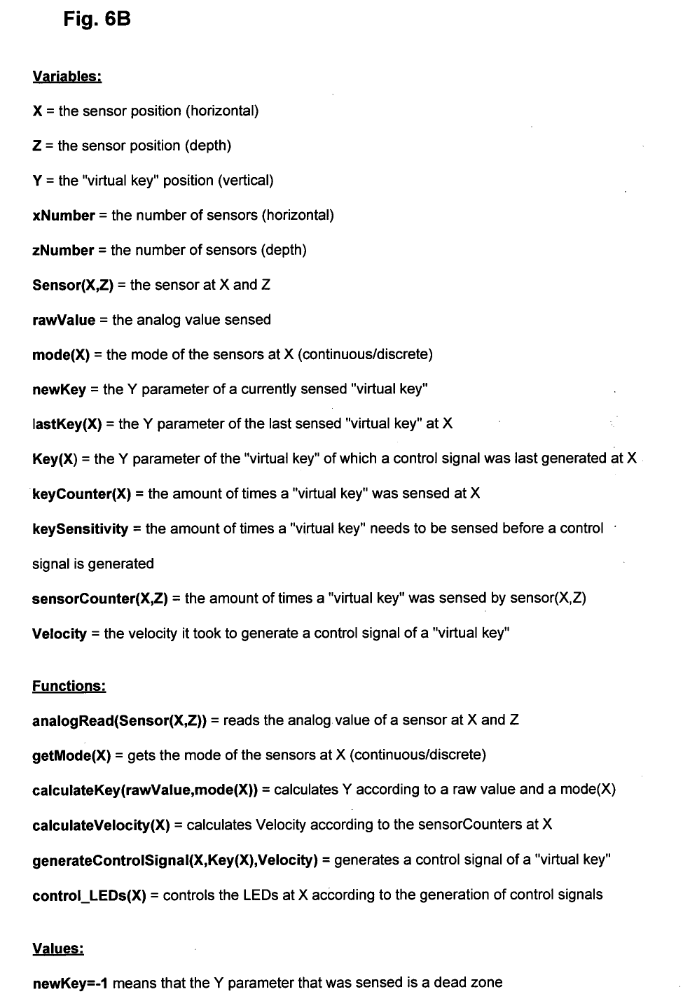

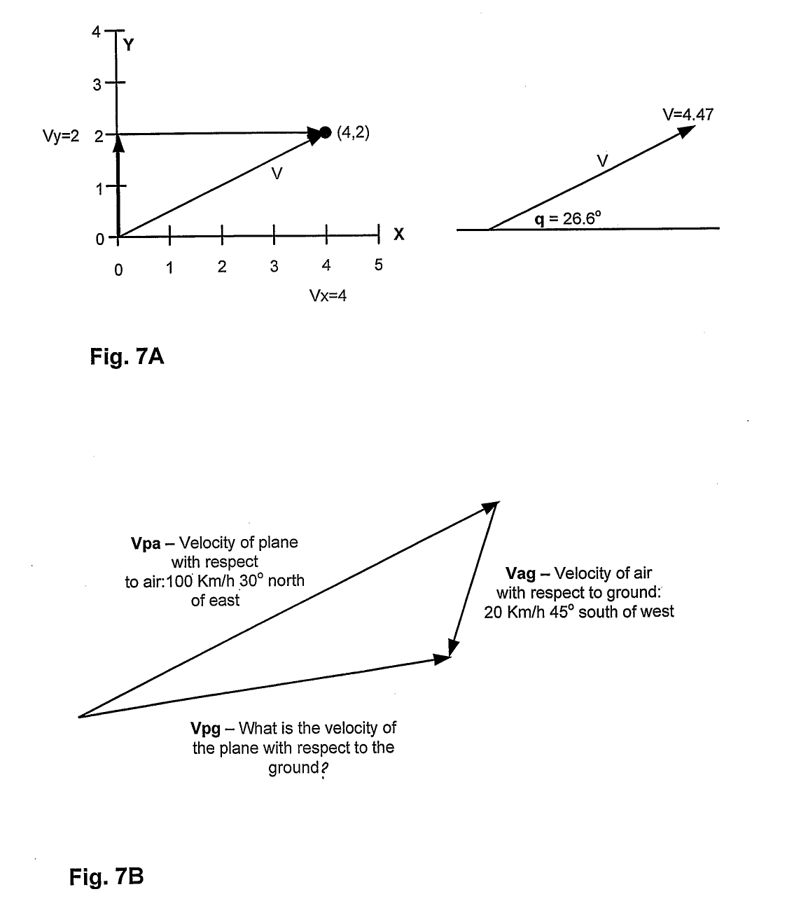

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to some embodiments of the present invention, there is provided a system and method for human machine interface.

According to further embodiments of the present invention, sensors or detectors (For example: SHARP's GP2D12—a distance measuring sensor with integrated signal processing and analog voltage output) may be arranged upon an interface base.

According to some embodiments of the present invention, the array of sensors may form a matrix (of one or more dimensions) of virtual keys. According to further embodiments of the present invention, positions of virtual keys may be described in reference to any X, Y and Z coordinate set, where: X denotes horizontal position; Y denotes vertical position; and Z denotes depth position.

According to some embodiments of the present invention, each of the sensors or detectors may be adapted to output an electrical signal indicating the distance of a user limb or a user manipulated object, from it.

According to some embodiments of the present invention, one or more signal-acquisition circuits may be adapted to receive the output signals from each of the sensors or detectors, whereas a signal processing logic may be adapted to estimate the position and a velocity vector of the limb or the user manipulated object in relation to the sensors.

According to some embodiments of the present invention, a command issuing logic may be adapted to convert the estimated position or velocity vector into a machine command, by referencing a mapping table.

Described below, are a few, known in the art, methods for calculating adding and subtracting vectors:

Vector Components

Any vector can be expressed as a sum of a number of other vectors. The vectors which are summed are called the components of the original vector. When one wants to add and subtract two dimensional vectors, it is convenient to express a vector as a sum of two components which are at right angles to each other. Typically one component is along a horizontal axis, and another vector is vertical. Any two dimensional vector can be expressed as a sum of one horizontal component and one vertical component. (In three dimensions it is necessary to add a third component at right angles to the other two.). In FIG. 9A the vector v is a sum of vectors vₓ and v_{y}: v=vₓ+v_{y}

The length of vₓ is written as vₓ without the bold face v. Likewise, the length of v_{y} is written as v_{y}. the length of the vector is calculated by adding the lengths of the components using the rule of Pythagoras: v²=vₓ²+v_{y}² The vector in our diagram has vₓ=4 and v_{y}=2 so v=4.47.

One can convey the direction of the vector by stating the angle it makes with the x axis, taking positive angles to be counterclockwise. From trigonometry the angle is θ=tan⁻¹(v_{y}/vₓ) Here tan⁻¹ means inverse tangent or arctangent not 1/tangent. (Computer applications often use “ATAN(x)” for the arctangent function.) In the example in the figure, tan⁻¹(2/4)=26.6 degrees. If you know the length and angle (A) of a vector you can get the size of the components from trigonometry as follows: vₓ=v cos(θ) v_{y}=v sin(θ)

Calculating the components from the length and angle of our example, 4.47 and 26.6 deg. There will be some round-off error but the answer should be accurate to three significant figures.

The rule for defining an angle may not always be easily understood, so it is a good idea to describe its steps. (For example, sometimes the angle may be referred to the y axis with positive angles being clockwise. In which case the angle of our vector would be 63.4 deg.) Furthermore, all of the ways of expressing vectors in terms of scalar numbers (x and y components or length and angle depend on the choice of coordinate system. The x axis does not have to be horizontal and the y axis is not required to be vertical. choosing another coordinate system will result in changed resulting numbers, even though the vector will remain the same. So when referring to vectors by scalar components the coordinate system must also be supplied. Dealing with vectors in three dimensions is more complicated. In the component representation, there are three components. If you express the vector using length and angle, there is still one length but there are two angles to specify, not one.

Adding and Subtracting Vectors

When facing a problem involving vectors, it's important to realize that vectors are not numbers. In particular one MUST add and subtract them like vectors. Do not plug numbers into a vector equation or formula. We have shown a simple geometrical representation of adding and subtracting vectors and one can do vector calculations by drawing an accurate scale diagram. Adding and subtracting by using the abovementioned rules for the arrow representation of vectors. (This works best in two dimensions.)

Three main forms of performing vector calculations are common. One may choose the one which seems best for you're the problem being faced.

1.1. Three ways to calculate with vectors
1. Draw an accurate scale drawing. You can multiply by scalars, add and subtract graphically, taking care to be as exact as possible. Measure the magnitudes and directions of the resulting vectors.
2. Use trigonometry. Some rules of trigonometry, such as the law of Pythagoras, apply only for right triangles. However, there are other, more complicated rules for general triangles such as the cosine law.
3. Establish a rectangular coordinate system and find the components of all vectors with respect to that coordinate system. Multiply by scalars, add and subtract the magnitudes of the components using algebra.

### Example

Airplane travelling in the wind—This is an example of an airplane travelling in the wind. The airplane flies in the air 100 km/h 30 degrees north of due east. However the wind is blowing at 45° south of due west (SW) at 20 km/h as shown in FIG. 9B. What is the velocity, speed and direction, that the plane travels with respect to the ground?

We can construct a scale drawing of the velocity vectors. Add the velocity of the plane with respect to the air, vpa to the velocity of the air with respect to the ground, vag. The sum is the velocity of the plane with respect to the ground, vpg: v_{pg}=vₚₐ+v_{ag} This is a vector equation. The sum of the speeds, 100 km/h+20 km/h, is not the resultant speed. You can measure the scale drawing to get a fair idea of the result. We can also do the problem by vector components:

1. Find x components and add them:

vₚₐₓ=vₚₐ cos(θₚₐ)=100 km/h)cos(30°)=86.6 km/h

v_{agx}=v_{ag} cos(θ_{ag})=20 km/h)cos(225°)=−14.1 km/h

v_{pgx}=86.6 km/h−14.1 km/h=72.5 km/h

2. Find the y components and add them

v_{pay}=vₚₐ sin(θₚₐ)=100 km/h)sin(30°)=50 km/h

v_{agy}=v_{ag} sin(θ_{ag})=20 km/h)sin(225°)=−14.1 km/h

v_{pgy}=50 km/h−14.1 km/h=35.9 km/h

3. Find magnitude and direction of resultant:

v_{pg}=sqrt(v_{pgx}²+v_{pgy}²)=80.8 km/h

θ=arctan(v_{pgy}/v_{pgx})=26.3°

According to some embodiments of the present invention, the output signals of the sensors or detectors may be an analog signal. The signal-acquisition circuits receiving the output signals from each of the sensors or detectors, may comprise an analog to digital converter for converting the analog signals they may receive into digital signals.

The present invention is a device, system and method for interfacing with an electronic appliance, including a sound generator. According to some embodiments of the present invention, there is provided an array of pulsed radiation emitters, wherein each emitter of the array may be associated with a different set of appliance control signals. The emitters may be generally oriented to emit pulsed radiation in a direction suitable for a user interaction. According to some embodiments of the present invention, the emitters may be oriented to emit radiation into a region where a user may extend his or her limb, or may extend an object using his or her limb.

According to some embodiments of the present invention, one or more detectors, functionally associated with the array, may be adapted to receive radiation emitted from one or more of the emitters and reflected by an interaction of a user (e.g. reflected off of a user's hand placed over the array). Signal processing circuitry may be adapted to receive an output from the detector and to determine user interaction based on one or more parameters of the radiation received by the detector. According to some embodiments of the present invention, the signal processing circuit may determine a user interaction (e.g. position and/or velocity and/or acceleration of a user limb) based on a phase delay (i.e. time of travel) between the emitted pulsed radiation and the received pulsed radiation. According to further embodiments of the present invention, the signal processing circuit may also factor in the relative positions of the emitter and the detector, in addition to the phase delay (i.e. time of travel), in determining a user interaction.

According to further embodiments of the present invention, there may be provided a mapping module adapted to associate a detected user interaction with a control signal to be output. According to further embodiments of the present invention, the mapping module may be adapted to associate a detected user interaction with two or more control signals to be outputted (i.e. a first control signal to a LED and a second control signal to another electronic device). According to some embodiments of the present invention, the mapping module may be adapted to associate every user interaction as a control signal, hence enabling a “continuous mode” wherein the user motion\movement is converted to a control signal in a substantially continuous manner. According to yet further embodiments of the present invention, the mapping module may be adapted to associate a portion of the user interaction with idle control signals (e.g. some user interactions are converted to control signals, and some are converted to idle control signals), hence enabling a “discrete mode” wherein the user motion\movement is converted to a control signal in a discrete manner while some user interactions are referred to as “dead zones” which are not generating an active control signal. According to yet further embodiments of the present invention, the mapping module may be configurable by the user.

The present invention is a method, circuit and system for interfacing with an electronic device such as a music device or a computing device. According to some embodiments of the present invention, the interfacing system may detect and sense light-blocking elements, and upon detection may generate a control signal to the electronic device.

According to some embodiments of the present invention, the system may include: (1) a controller, (2) a mode selection module (“mapping module”) and (3) a Virtual Matrix Generator (“VMG”). According to some embodiments of the present invention, the VMG may include: (1) an array of radiating elements and (2) a detector array, which radiation array and detection array may be functionally coupled as explained herein below.

According to some further embodiments of the present invention, the controller may generate a control signal based on one or more parameters passed from the Virtual Matrix Generator.

According to some embodiments of the present invention, the Virtual Matrix Generator may be an array of Virtual Key Generators (“VKG”). According to some further embodiments of the present invention, the Virtual Matrix Generator may associate an indicator with a Virtual Key Generator. According to yet further embodiments of the present invention, the Virtual Matrix Generator may send the controller an indicator associated with a Virtual Key Generator.

According to some embodiments of the present invention, a Virtual Key Generator may be adapted to detect elements by means of a detection element adapted to detect reflected radiation. According to some further embodiments of the present invention, upon detecting an element by a Virtual Key Generator, the Virtual Matrix Generator may be adapted to calculate a parameter associated with the detected element.

According to some embodiments of the present invention, the Virtual Matrix Generator may send to the controller an indicator associated with a Virtual Key Generator and a parameter associated with a detected element. According to yet some further embodiments of the present invention, the controller may generate a control signal based on the passed parameters.

According to some embodiments of the present invention, a radiating element may be adapted to transmit (emit) radiation (i.e. infra red radiation). According to some embodiments of the present invention, a detecting element may be adapted to detect and sense reflected radiation (i.e. infra red). According to yet further embodiments of the present invention, a detecting element and a radiating element may be functionally coupled by arranging the two elements in such a way that will guarantee that the radiation detected by a detection element was transmitted by the radiating element.

According to some embodiments of the present invention, a detection element and a radiation element functionally coupled as described herein above may be referred to as a Virtual Key Generator (“VKG”).

According to some embodiments of the present invention, the Virtual Matrix Generator may include an array of pulsed radiation emitters, wherein each emitter of the array is a Virtual Key Generator and may be associated with a different set of appliance control signals. The emitters may be generally oriented to emit pulsed radiation in a direction suitable for a user interaction. According to some embodiments of the present invention, the emitters may be oriented to emit radiation into a region (“a Virtual Matrix”) where a user may extend his or her limb, or may extend an object using his or her limb.

According to some embodiments of the present invention, the Virtual Matrix Generator may include one or more detectors, functionally associated with the array of pulsed radiation emitters, and may be adapted to receive radiation emitted from one or more of the emitters and reflected by an interaction of a user in the virtual matrix region. The controller may include a Signal processing circuitry, which Signal processing circuitry may be adapted to receive an output from the detector and to determine user interaction based on one or more parameters of the radiation received by the detector. According to some embodiments of the present invention, the signal processing circuit may determine a user interaction (e.g. position and/or velocity and/or acceleration of a user limb) based on a phase delay (i.e. time of travel) between the emitted pulsed radiation and the received pulsed radiation. According to further embodiments of the present invention, the signal processing circuit may also factor in the relative positions of the emitter and the detector, in addition to the phase delay (i.e. time of travel), in determining a user interaction.

According to further embodiments of the present invention, the mode selection module may include a mapping module, which mapping module may be adapted to associate a detected user interaction with a control signal to be output. According to some embodiments of the present invention, the mapping module may be adapted to associate every user interaction as a control signal, hence enabling a “continuous mode” wherein the user motion\movement is converted to a control signal in a substantially continuous manner. According to yet further embodiments of the present invention, the mapping module may be adapted to associate a portion of the user interaction with idle control signals (e.g. some user interactions are converted to control signals, and some are converted to idle control signals), hence enabling a “discrete mode” wherein the user motion\movement is converted to a control signal in a discrete manner while some user interactions are referred to as “dead zones” which are not generating an active control signal. According to yet further embodiments of the present invention, the mapping module may be configurable by the user.

In FIG. 8 there is shown an exemplary logic flow of a controller in accordance with some embodiments of the present invention. To begin with variables representing: the X-dimension (horizontal) and Z-dimension (depth) sensor positions; the Y parameter of a currently sensed “virtual key”; the Y parameter of the last sensed “virtual key” at X; the Y parameter of the “virtual key” of which a control signal was last generated at X; the amount of times a “virtual key” was sensed at X; and the amount of times a “virtual key” was sensed by sensor(X,Z)—are given a value of 0 (step 100).

A variable representing the analog value sensed—is given the analog value of the sensor positioned at X and Z; a variable representing the mode of the sensors at X (continuous/discrete) gets the current mode of the sensors; and a variable representing the Y parameter of a currently sensed “virtual key” is given the value of Y—calculated according to a raw value (e.g. the raw picked-up values are transformed into a linear scale, corresponding to the actual distance of the reflecting object from the sensor) and the mode of the sensors at X (step 200).

If the Y parameter of a currently sensed “virtual key is not equal to the Y parameter of the “virtual key” of which a control signal was last generated at X; the Y parameter of a currently sensed “virtual key” is not equal to a value representing a dead zone (e.g. the value [−1]); and the Y parameter of a currently sensed “virtual key” is equal to the Y parameter of the last sensed “virtual key” at X—the condition (step 300) is fulfilled. The AND operator used between the operands is of a && type, i.e. evaluating from left to right, when one of the conditions is found to be FALSE, the remaining ones will not be further checked and the result of the whole condition will be determined to be likewise FALSE.

If the condition of step 300 is fulfilled (i.e. TRUE) a variable representing the amount of times a “virtual key” was sensed at X is incremented (step 320); else wise, it is given the value 0 and a variable representing the Y parameter of the last sensed “virtual key” at X is given the value of the Y parameter of a currently sensed “virtual key” (step 310). After performing either step 320 or step 310 (in accordance with the result of the condition) the process proceeds to step 400.

If the Y parameter of a currently sensed “virtual key” is not equal to the Y parameter of the “virtual key” of which a control signal was last generated at X (step 400), a variable representing the amount of times a “virtual key” was sensed by the sensor at X and Z is incremented (step 420); else wise, it is given the value 0 (step 410). After performing either step 420 or step 410 (in accordance with the result of the condition) the process proceeds to step 500.

If the amount of times a “virtual key” was sensed at X is equal to the amount of times a “virtual key” needs to be sensed before a control signal is generated (step 500) a variable representing the velocity it took to generate a control signal of a “virtual key” is given the velocity value calculated according to the variables representing the amount of times a “virtual key” was sensed by each of the sensors at X (the time deltas between two or more “virtual key” sensings made by the sensors at two or more Z locations at X); a variable representing the Y parameter of the “virtual key” of which a control signal was last generated at X is given the value of the variable representing the Y parameter of a currently sensed “virtual key”; a control signal of a “virtual key” is accordingly generated; and the LEDs at X are controlled according to the generated control signals (step 520). After either performing step 520 or directly after step 500 (in accordance with a FALSE condition result) the process proceeds to step 600 where the value of the variable representing the Z-dimension (depth) position of the sensor is incremented (step 600).

If after incrementing the variable representing the Z-dimension (depth) position of the sensor its value is smaller than the value of the variable representing the number of Z-dimension (depth) sensors (step 700) the process returns to step 200; else wise, the variable representing the Z-dimension (depth) position of the sensor is given the value 0; and the value of the variable representing the X-dimension (horizontal) position of the sensor is incremented (710) and the process proceed to step 800.

If after incrementing the variable representing the X-dimension (horizontal) position of the sensor its value is smaller than the value of the variable representing the number of X-dimension (horizontal) sensors (step 800) the process returns to step 200; else wise, the variable representing the X-dimension (horizontal) position of the sensor is given the value 0 (step 810); and the process returns to step 200.

Below, described in pseudo-code, is an arrangement and method of mapping human interaction to machine commands in accordance with some exemplary embodiments of the present invention:

A matrix with the total of 24 virtual keys (8 horizontal×3 vertical) generated by a total of 16 sensors (8 horizontal×2 depth).

(Step 200 in FIG. 8A)

the sensor that is currently being read is located at X=5 (sixth horizontal location) and Z=0 (first depth location).

the analog value of this sensor is currently 247.

the mode of the sensor's horizontal location (X) is discrete mode.

the calculateKey function examines the sensor's analog value and mode and then returns the value 2, which indicates the virtual key currently sensed by the sensor.

(Step 300 in FIG. 8A)

the virtual key currently sensed is different from the virtual key of which a control signal was last generated at X, which means that there is a new case.

the virtual key currently sensed is also different from the value −1 which represents a dead zone between the virtual keys.

the virtual key currently sensed is equal to the last sensed virtual key at X, which means that both sensors at X sensed the same virtual key one after the other.

(Step 320 in FIG. 8A)

the keyCounter of the sensors at X is incremented, and now has the value 10.

(Step 400 in FIG. 8A)

the virtual key currently sensed is different from the virtual key of which a control signal was last generated at X.

(Step 420 in FIG. 8A)

the sensorCounter of the sensor is incremented, and now has the value 108.

(Step 500 in FIG. 8A)

the keyCounter of the sensors at X is equal to the amount of times a virtual key needs to be sensed before a control signal is generated, so now the virtual key currently sensed could be activated by a generated control signal.

(Step 520 in FIG. 8A)

the velocity it took for the key activation is calculated as the delta of the sensorCounters (108−5=103).

the virtual key of which a control signal was last generated at X is now the virtual key currently sensed

a control signal of the activation of the virtual key and the velocity of the activation is generated. As a result and according to the users settings, a “Note ON” MIDI message for the note “G2” with the MIDI velocity parameter 103 is sent to a MIDI sound engine.

the LEDs assigned to the activated virtual key are turned on.

(Step 600 in FIG. 8A)

the sensor location Z is incremented, and now has the value 1

Z is smaller than the number of Z-dimension (depth) sensors (which is 2 in this example), so the process returns to step [200] with the examination of the next sensor in this dimension.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A human machine interface comprising:
a set of light emitting ranging sensors/detectors arranged upon an interface base, wherein each of said sensors/detectors is adapted to output an electrical signal indicating a distance of a user limb or a user manipulated object from said sensor;
one or more signal acquisition circuits adapted to receive the output signals from each of said sensor/detector;
signal processing logic adapted to estimate position and a velocity vector of the limb or object relative to said set of sensors; and
command issuing logic adapted to convert the estimated position and/or velocity vector into a machine command based on a mapping table.

2. The interface according to claim 1, wherein the output signals from said sensors/detectors are analog.

3. The interface according to claim 2, wherein said one or more acquisition circuits comprise an analog to digital converter.

4. The interface according to claim 3, wherein sensors' output is transformed to commands in a continuous mode.

5. The interface according to claim 3, wherein sensors' output is transformed to commands in a discrete mode.

6. A musical instrument interface comprising:
a set of light emitting ranging sensors/detectors arranged upon an interface base, wherein each of said sensors/detectors is adapted to output an electrical signal indicating a distance of a user limb or a user manipulated object from said sensor;
one or more signal acquisition circuits adapted to receive the output signals from each of said sensor/detector;
signal processing logic adapted to estimate position and a velocity vector of the limb or object relative to said set of sensors; and
command issuing logic adapted to convert the estimated position and/or velocity vector into a Musical Instrument Digital Interface (“MIDI”) command based on a mapping table.

7. The musical instrument interface according to claim 6, wherein the output signals from said sensors/detectors are analog.

8. The musical instrument interface according to claim 7, wherein said one or more acquisition circuits comprise an analog to digital converter.

9. The musical instrument according to claim 8, wherein sensors' output is transformed to commands in a continuous mode.

10. The musical instrument according to claim 8, wherein sensors' output is transformed to commands in a discrete mode.

11. A method for interfacing with a machine comprising:
sensing limb/object position or movement with a set of light emitting ranging sensors/detectors arranged upon an interface base;
outputing an electrical signal indicating a limb or object position or movement;
estimating position and a velocity vector of the limb or object relative to said set of sensors; and
converting the estimated position and/or velocity vector into a machine command by referencing a mapping table.

12. The method according to claim 11, further comprising generating an analog signal.

13. The method according to claim 12, further comprising converting the analog signal to a digital signal.

14. The method according to claim 13, wherein converting of sensors' output is executed in a continuous mode.

15. The method according to claim 13, wherein converting of sensors' output is executed in a discrete mode.
